(19) United States
(12) Patent Application Publication
(10) Pub. No.: US 2017/0188073 A1
(43) Pub. Date: Jun. 29, 2017

(54) METHOD, DEVICE AND SYSTEM FOR ADJUSTING ELEMENT

(71) Applicants: BOE TECHNOLOGY GROUP CO., LTD., Beijing (CN); BEIJING BOE MULTIMEDIA TECHNOLOGY CO., LTD., Beijing (CN)

(72) Inventors: Qinqin CAO, Beijing (CN); Caixia GUO, Beijing (CN); Bendeng LV, Beijing (CN); Wanli XU, Beijing (CN)

(73) Assignees: BOE TECHNOLOGY GROUP CO., LTD., Beijing (CN); BEIJING BOE MULTIMEDIA TECHNOLOGY CO., LTD., Beijing (CN)

(21) Appl. No.: 15/302,127

(22) PCT Filed: Dec. 23, 2015
(86) PCT No.: PCT/CN2015/098352

§ 371 Date: Oct. 5, 2016

(30) Foreign Application Priority Data
Jul. 27, 2015 (CN) 201510446900.3

(51) Int. Cl. H04N 21/41; H04N 21/462; G06F 3/048; H04N 21/458; H04N 21/254; H04N 21/472; H04N 21/437; H04N 21/422; H04L 29/06

(52) U.S. Cl. CPC H04N 21/4104; H04N 21/42207; H04N 21/462; G06F 3/048; H04L 65/4092; H04N 21/254; H04N 21/472; H04N 21/437; H04N 21/458; H04N 21/42204

(57) ABSTRACT

The present disclosure discloses a method, device and system for adjusting elements. The method includes receiving a code value sent by a remote control device, detecting whether an element determined to be modified with the code value exists in a page currently provided by a media source device, when the element determined to be modified with the code value exists in the page currently provided by the media source device, modifying the element according to the code value, and if the element determined to be modified with the code value does not exist in the page currently provided by the media source device, sending the code value to a playing device connected with the media source device.

### CROSS-REFERENCE TO RELATED APPLICATION

The preset application claims the priority of Chinese patent application No. 201510446900.3 filed in China on Jul. 27, 2015, the disclosure of which is incorporated in their entirety by reference herein.

### TECHNICAL FIELD

The present disclosure relates to the field of smart television, and in particular, to a method, a device and a system for adjusting elements.

### BACKGROUND

In the field of smart television playing, a smart television is generally used in conjunction with a Set-Top-Box, wherein the Set-Top-Box can transmit obtained video data to the smart television to be played by the smart television.

Currently, when the smart television is used, each of the smart television and the Set-Top-Box used conjunctively is equipped with a remote control. The smart television receives signals transmitted by one remote control corresponding to the television, to turn on/off the television or to open menus of the smart television, or to adjust the volume of the smart television. The Set-Up-Box receives signals sent from another remote control corresponding to the Set-Up-Box, to change channels or adjust the volume.

In a process of implementing the present disclosure, the inventors have found at least the following problems existed in the related art: because each set of the smart television and the Set-Up-Box is equipped with two remote controls, when a user uses the different remote controls to control the smart television and the Set-Top-Box respectively, the user often confuses the device that one of the remote controls can control, resulting in a low hit ratio that one of the remote controls hits its corresponding device.

### SUMMARY

To solve such the problem in the related art that since each set of the smart television and the Set-Top-Box is generally equipped with two remote control devices, a user often confuses the device that one of the two remote control devices can control when the user operates the television and the Set-Top-Box using the different remote control devices respectively, and a hit ratio that one of the remote controls hits its corresponding device is low, embodiments of the present disclosure provides a method, a device and a system for adjusting elements. The technical solutions of the present disclosure are as follow.

In a first aspect, a method for adjusting elements, which is applied to a media source device is provided, the method includes:

receiving a code value sent from a remote control device, the code value being generated by pressing down one of buttons on the remote control device;

detecting whether an element that is determined by the code value to be modified exists in a page currently provided by the media source device;

modifying the element that is determined by the code value to be modified according to the code value when the element that is determined by the code value to be modified exists in the page currently provided by the media source device; and

sending the code value to a playing device connected with the media source device when the element that is determined by the code value to be modified does not exist in the page currently provided by the media source device, to cause the playing device to modify the element that is determined by the code value to be modified in a page currently displayed by the playing device.

Optionally, the method further includes:

after the media source device is turned on, sending a handshake request to the playing device connected with the media source device, the handshake request being configured to trigger the playing device to feed back a handshake response which carries a type of the playing device;

receiving the handshake response fed back from the playing device;

acquiring the type of the playing device carried in the handshake response; and

determining whether the playing device is matched with the media source device according to a stored list of types of playing devices and the type of the playing device, the list of types storing at least one type of one playing device matched with the media source device.

Optionally, after determining whether the playing device is matched with the media source device, the method further includes:

when the playing device is matched with the media source device, sending elements of predetermined types in the media source device to the playing device to cause the playing device to synchronize the elements of predetermined types, the elements of predetermined types being elements predetermined to be synchronized between the playing device and the media source device; and

receiving synchronized elements fed back from the playing device.

Optionally, after determining whether the playing device is matched with the media source device, the method further includes: when the playing device is not matched with the media source device, forbidding sending the elements of predetermined types in the media source device to the playing device, and forbidding the media source device to send a received code value to the playing device.

Optionally, after sending the handshake request to the playing device connected with the media source device, the method further includes: when not receiving the handshake response fed back by the playing device, sending to the playing device a turn-on signal for turning on the playing device.

Optionally, after modifying the element that is determined by the code value to be modified according to the code value, the method further includes: forbidding sending the code value to the playing device.

Optionally, modifying the element that is determined by the code value to be modified according to the code value includes:

based on a modification pattern pre-stored for modifying elements using code values, modifying the element that is determined by the code value to be modified according to the code value;

wherein the modification pattern at least includes adjusting a value of a corresponding element according to the code value or adjusting a property of the corresponding element according to the code value.

In a second aspect, a method for adjusting elements, which is applied to a playing device is provided, the method includes:

receiving a code value sent from a media source device connected with the playing device, the code value being generated by pressing down one of buttons on a remote control device and sent to the media source device;

detecting whether an element that is determined by the code value to be modified exists in a page currently displayed by the playing device;

adjusting the element that is determined by the code value to be modified according to the code value, when the element that is determined by the code value to be modified exists in the page currently displayed by the playing device.

Optionally, the method further includes:

receiving a handshake request sent by the media source device;

acquiring a type of the playing device; and

adding the type of the playing device into a handshake response and sending the handshake response to the media source device.

Optionally, the method further includes:

receiving elements of predetermined types sent by the media source device;

synchronizing corresponding elements in the playing device according to the elements of predetermined types; and

sending synchronized elements to the media source device.

In a third aspect, a media source device is provided which includes:

a code-value receiving module configured to receive a code value sent from a remote control device, the code value being generated by pressing down one of buttons on the remote control device;

a detection module configured to detect whether an element that is determined by the code value to be modified exists in a page currently provided by the media source device;

an element modification module configured to modify the element that is determined by the code value to be modified according to the code value, when the detection module detects that the element that is determined by the code value to be modified exists in the page currently provided by the media source device; and

a code-value sending module configured to, when the detection module detects that the element that is determined by the code value to be modified does not exist in the page currently provided by the media source device, send the code value to a playing device connected with the media source device to cause the playing device to modify the element that is determined by the code value to be modified in a page currently displayed by the playing device according to the code value.

Optionally, the media source device further includes:

a request sending module configured to, after the media source device is turned on, send a handshake request to the playing device connected with the media source device, the handshake request being configured to trigger the playing device to feed back a handshake response which carries a type of the playing device;

a response receiving module configured to receive the handshake response fed back from the playing device;

a type acquisition module configured to acquire a type of the playing device carried in the handshake response received by the response receiving module; and

a match determination module configured to determine whether the playing device is matched with the media source device according to a stored list of types of playing devices and the type of the playing device, the list of types storing at least one type of one playing device matched with the media source device.

Optionally, the media source device further includes:

an element sending module configured to, when the match determination module determines that the playing device is matched with the media source device, send elements of predetermined types in the media source device to the playing device to cause the playing device to synchronize the elements of predetermined types, the elements of predetermined types being elements predetermined to be synchronized between the playing device and the media source device; and

an element receiving module configured to receive synchronized elements fed back from the playing device.

Optionally, the media source device further includes: a first forbidding module configured to, when the match determination module determines that the playing device is not matched with the media source device, forbid the element sending module to send the elements of predetermined types in the media source device to the playing device, and forbid the media source device to send the received code value to the playing device.

Optionally, the media source device further includes: a signal sending module configured to, when the response receiving module does not receive the handshake response fed back by the playing device, send to the playing device a turn-on signal for turning on the playing device.

Optionally, the media source device further includes: a second forbidding module configured to forbid sending the code value to the playing device after the element is modified according to the code value.

Optionally, the element modification module is further configured to:

based on a modification pattern pre-stored for modifying elements using code values, modify the element according to the received code value, the modification pattern at least including adjusting a value of a corresponding element according to the code value or adjusting a property of the corresponding element according to the code value.

In a fourth aspect, a playing device is provided which includes:

a code-value receiving module configured to receive a code value sent from a media source device connected with the playing device, the code value being generated by pressing down one of buttons on a remote control device and sent to the media source device;

a detection module configured to detect whether an element that is determined by the code value to be modified exists in a page currently displayed by the playing device;

an element modification module configured to adjust the element that is determined by the code value to be modified according to the code value, when the detection module detects that the element that is determined by the code value to be modified exists in the page currently displayed by the playing device.

Optionally, the playing device further includes:

a request receiving module configured to receive a handshake request sent by the media source device;

a type acquisition module configured to acquire a type of the playing device; and

a response sending module configured to add the type of the playing device acquired by the type acquisition module into a handshake response and send the handshake response to the media source device.

Optionally, the playing device further includes:

an element receiving module configured to receive elements of predetermined types sent by the media source device;

an element synchronization module configured to synchronize corresponding elements in the playing device according to the elements of predetermined types received by the element receiving module; and

an element sending module configured to send the elements synchronized by the element synchronization module to the media source device.

In a fifth aspect, a system for adjusting elements is provided which at least includes the media source device provided in the third aspect and the various implementations of the third aspect, and the playing device provided in the fourth aspect and the various alternative implementations of the fourth aspect.

The advantages of the technical solutions of the embodiments of the present disclosure are as follows.

The media source device receives the code value sent from the remote control device, and determines whether to modify an element in a currently provided page is to be modified according to the code value. When no element is to be modified, then the media source device transmits the code value to the playing device to cause the playing device to modify an element in a currently displayed page. Because only one remote control device is needed to implement controlling of the media source device and the playing device, thus it can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. It may achieve such effects that a single remote control device can be used to control the media source device and the playing device simultaneously, operation is simple and a hit ratio of the remote control device can be increased.

### BRIEF DESCRIPTION OF THE DRAWINGS

In order to more clearly illustrate technical solutions of embodiments of the present disclosure, the drawings used in the description of the embodiments will be briefly discussed hereinafter. Obviously, the following figures are only some of the embodiments of the present disclosure, and one skilled in the art may derive other figures based on these figures without paying any creative labor.

FIG. 1 is a schematic diagram of an implementation environment related with a method for adjusting elements provided in some embodiments of the present disclosure;

FIG. 2 is a flow chart of a method for adjusting elements provided in at least one embodiment of the present disclosure;

FIG. 3 is a flow chart of a method for adjusting elements provided in at least one embodiment of the present disclosure;

FIG. 4A is a flow chart of a method for adjusting elements provided in at least one embodiment of the present disclosure;

FIG. 4B is a flow chart of a method for adjusting elements provided in at least one embodiment of the present disclosure;

FIG. 5 is a schematic diagram of a media source device provided in at least one embodiment of the present disclosure;

FIG. 6 is a schematic diagram of a media source device provided in at least one embodiment of the present disclosure;

FIG. 7 is a schematic diagram of a playing device provided in at least one embodiment of the present disclosure;

FIG. 8 is a schematic diagram of a playing device provided in at least one embodiment of the present disclosure; and

FIG. 9 is a schematic diagram of a system for adjusting elements provided in at least one embodiment of the present disclosure.

### DETAILED DESCRIPTION

To make objectives, technical solutions and advantages of the present disclosure more clear, the embodiments of the present disclosure will be further described in detail hereinafter with respect to the drawings.

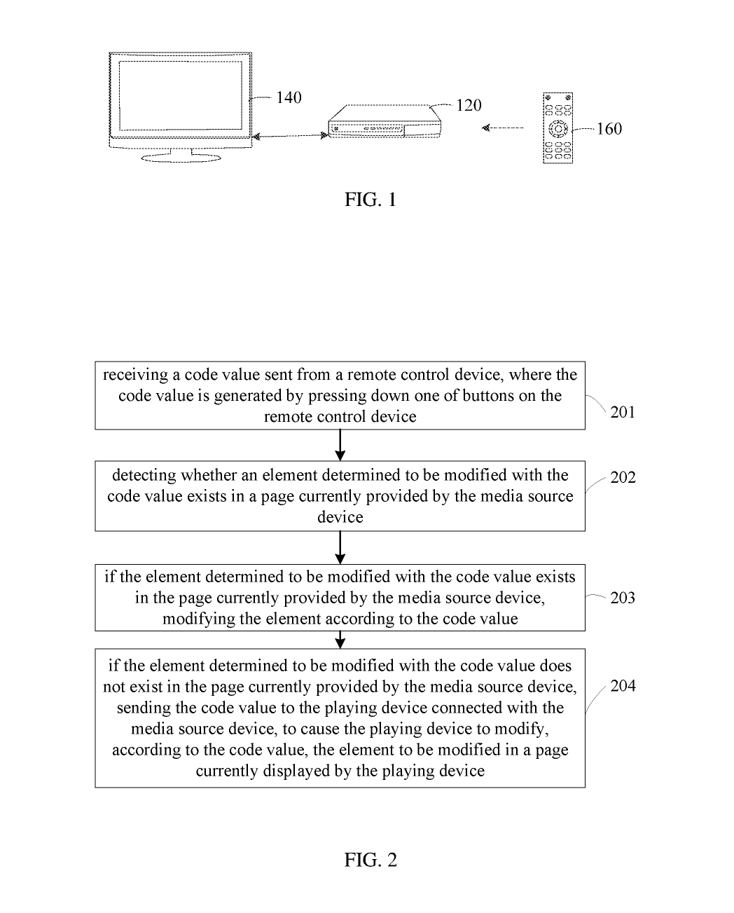

FIG. 1 is a schematic diagram of an implementation environment related with a method for adjusting elements provided in some embodiments of the present disclosure. The implementation environment at least includes a media source device 120 and a playing device 140.

The media source device 120 is generally a device that can be connected with the playing device 140 and provide the playing device 140 with multimedia data. For example, the media source device 120 may be a network Set-Top-Box, a cable Set-Top-Box, and so on.

The playing device 140 is a device that can play the multimedia data. For example, the playing device 140 may be a smart television, a computer and the like.

The implementation environment may further include a remote control device 160.

The remote control device 160 is bounded with the playing device 140 and the media source device 120 simultaneously, and can transmit a code value to the playing device 140 and the media source device 120.

FIG. 2 is a flow chart of a method for adjusting elements provided in at least one embodiment of the present disclosure. This method is illustrated mainly by applying the method to the media source device 120 in the implementation environment shown in FIG. 1. The method may include following steps.

Step 201 is to receive a code value sent from a remote control device. The code value is generated by pressing down one of buttons on the remote control device.

Step 202 is to detect whether an element that is determined by the code value to be modified exists in a page currently provided by the media source device.

Step 203 is to modify the element according to the code value when the element that is determined by the code value to be modified exists in the page currently provided by the media source device;

Step 204 is to send the code value to the playing device connected with the media source device when the element that is determined by the code value to be modified does not exist in the page currently provided by the media source device, so that the playing device modifies the element that is determined by the code value to be modified in a page currently displayed by the playing device according to the code value.

According to the above, in the method for adjusting elements in the embodiments of the present disclosure, the media source device receives the code value sent from the remote control device, and determines whether to modify one element in the currently provided page according to the code value. If no element is to be modified, the media source device transmits the code value to the playing device so that the playing device modifies one element in the currently displayed page. Because only one remote control device is required to implement controlling of the media source device and the playing device, thus the method can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. The method may achieve such effects that a single remote control device can be used to control the media source device and the playing device simultaneously, operation is simple and a hit ratio of the remote control device can be increased.

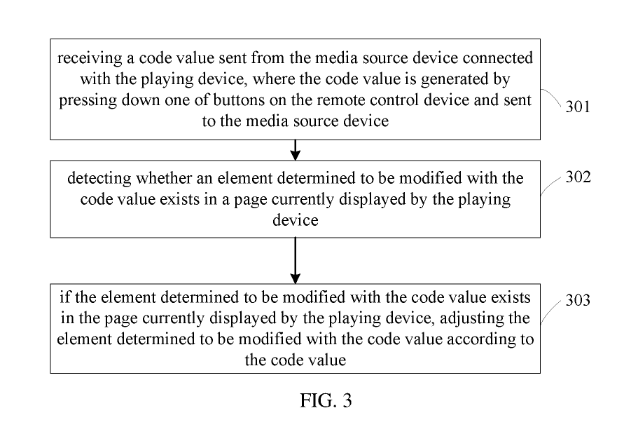

FIG. 3 is a flow chart of a method for adjusting elements provided in at least one embodiment of the present disclosure. This method is illustrated mainly by applying the method to the playing device 140 in the implementation environment shown in FIG. 1. The method may include the following steps.

Step 301 is to receive a code value sent from the media source device connected with the playing device. The code value is generated by pressing down one of buttons on the remote control device and sent to the media source device.

Step 302 is to detect whether an element that is determined by the code value to be modified exists in a page currently displayed by the playing device.

Step 303 is to adjust the element that is determined by the code value to be modified according to the code value when the element that is determined by the code value to be modified exists in the page currently displayed by the playing device.

According to the above, in the method for adjusting elements provided in the embodiments of the present disclosure, the media source device receives the code value sent from the remote control device, and determines whether to modify one element in a currently provided page according to the code value. If no element is to be modified, the media source device transmits the code value to the playing device, so that the playing device modifies one element in the currently displayed page. Because only one remote control device is required to implement controlling of the media source device and the playing device, thus the method can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. The method may achieve such effects that a single remote control device can be used to control the media source device and the playing device simultaneously, operation is simple and a hit ratio of the remote control device can be increased.

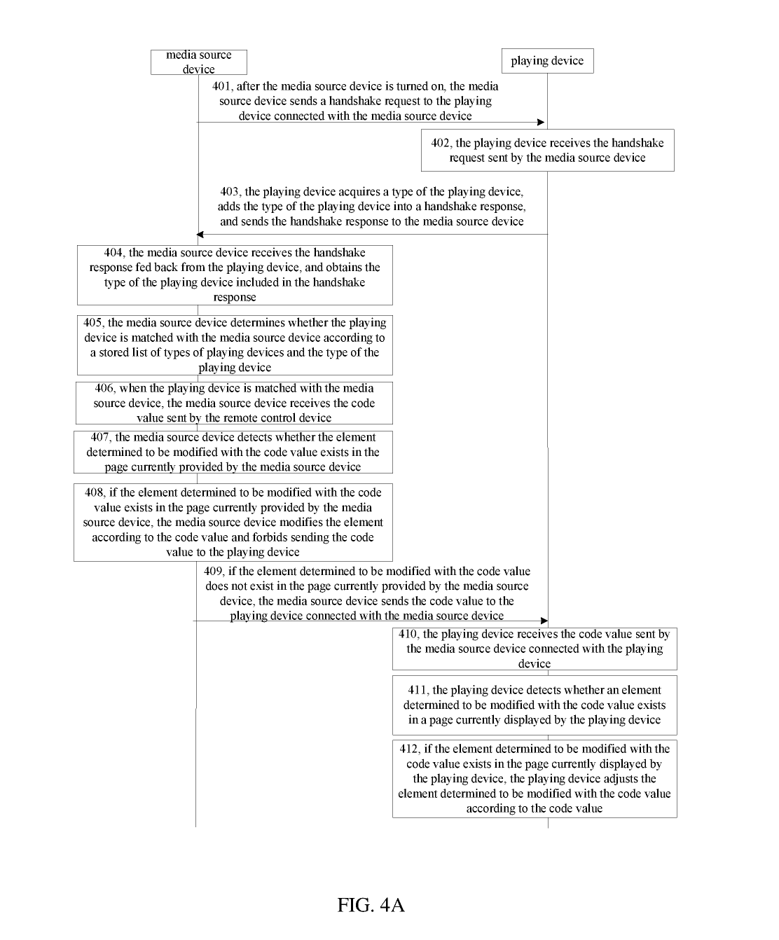

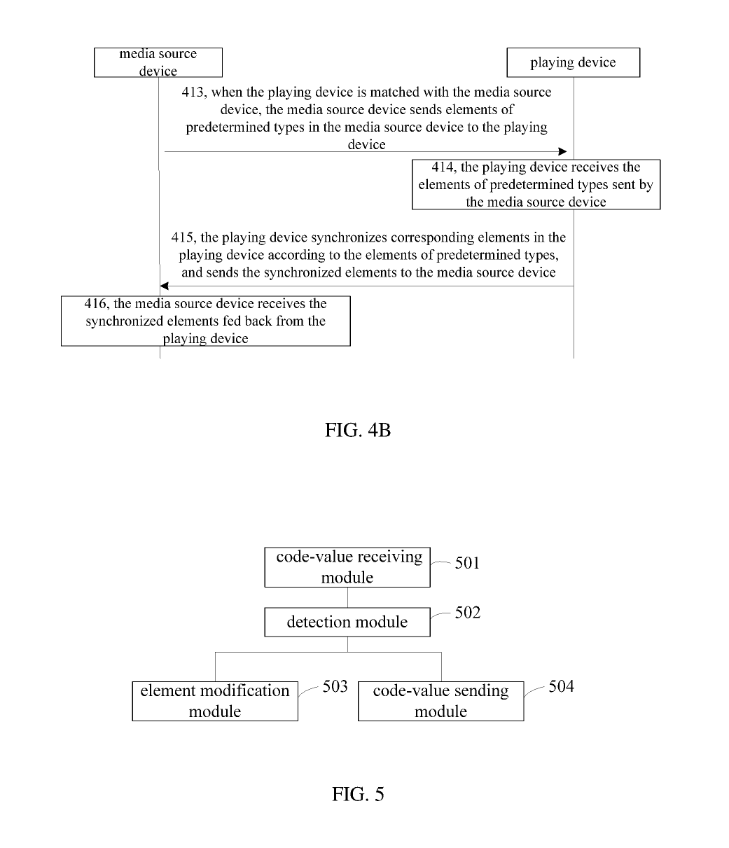

In actual applications, when a single remote control device controls a group of the media source device and the playing device, the code value generated by the remote control device may be sent to the media source device first, and then the media source device determines one of the media source device and the playing device to respond to the code value. Such implementation is specifically described in FIG. 4A and FIG. 4B.

FIG. 4A is a flow chart of a method for adjusting elements provided in at least one embodiment of the present disclosure. This method is illustrated mainly by applying the method to the implementation environment shown in FIG. 1. The method may include the following steps.

Step 401 is to, after the media source device is turned on, send, by the media source device, a handshake request to the playing device connected with the media source device.

In actual applications, after the media source device is successfully turned on, the playing device is also required to be turned on in order to ensure that the playing device can normally play the multimedia contents. Thus, after the media source device is turned on, the media source device generally sends a handshake request to the playing device connected with the media source device.

Additionally, in order to ensure that the single remote control device can control the playing device by means of the media source device when controlling the media source device, it is also required that the playing device and the media source device are successfully connected and matched. In doing so, the media source device may also send the handshake request to the playing device to determine whether the play device and media source device are successfully matched or connected.

Obviously, if the playing device is not connected with the media source device, the media source device cannot send the handshake request to the playing device successfully. Thus, the user needs to ensure that the playing device is successfully connected with the media source device.

When the media source device sends the handshake request to the playing device, the handshake request may be sent via a connection line between the playing device and the media source device.

Step 402 is to receive, by the playing device, the handshake request sent by the media source device.

When the playing device and the media source device are connected successfully, the playing device can successfully receive the handshake request sent by the media source device.

Step 403 is to acquire, by the playing device, a type of the playing device, add the type of the playing device into a handshake response, and send the handshake response to the media source device.

In actual applications, code values generated by different remote control devices may be obtained by encoding in various encoding methods. An encoding method of code values for the remote control device needs to correspond to decoding methods of the media source device and the playing device. In such way, the code values generated by the remote control device can be identified by the media source device and the playing device. Thus, a same decoding pattern for decoding the code values of the single remote control device is generally required by the media source device and the playing device when identifying the code values of the single remote control device. That is, the matched media source device and the playing device adopt the same decoding pattern for the same set of code values.

Thus, in order to ensure that the playing device and the media source device can identify the code value of the remote control device simultaneously, it is needed to ensure that the playing device and the media source device adopt the same decoding patterns for the code value of the remote control device. That is, it is needed to ensure that the playing device and the media source device are matched.

When the playing device successfully receives the handshake request sent by the media source device, the playing device may add its type into the handshake response to the handshake request and send the handshake response with the type of the playing device to the media source device, so that the media source device can determine whether the playing device is matched with the media source device after the media source device receives the handshake response. In specific implementations, in order to facilitate determination made by the media source device, the media source device may store in advance types of playing devices matched therewith. That is, the matched media source device and the playing device can correctly identify the code values of the remote control device.

When the playing device sends the handshake response to the media source device, the handshake response may be sent via a connection line between the playing device and the media source device.

Optionally, the playing device and the media source device may be connected via a high definition multimedia interface (HDMI) line. For the purpose of facilitating transmission of the handshake request and the handshake response, Pin 13 of the HDMI may be used as TX, and Pin 14 may be used as RX. The media source device sends the handshake request by means of the Pin 13 using a handshake protocol, and receives the handshake response to the handshake request by means of the Pin 14, to implement handshaking with the playing device.

Step 404 is to receive, by the media source device, the handshake response fed back from the playing device, and obtain the type of the playing device included in the handshake response.

Step 405 is to determine, by the media source device, whether the playing device is matched with the media source device according to a stored list of types of playing devices and the obtained type of the playing device.

The list of types of playing devices herein stores at least one type of playing device matched with the media source device.

When the media source device determines the obtained type of the playing device is in the list, it can be determined that the playing device is matched with the media source device.

That is to say, if the obtained type in the handshake response is not in the list of types of playing devices stored in the media source device, it indicates that the playing device connected with the media source device cannot share a single remote control device with the media source device, i.e., the playing device is incapable of correctly identifying the code value sent from the media source device or incapable of modifying an element on the currently displayed page according to the identified code value.

Step 406 is to receive, by the media source device, the code value sent by the remote control device, when the playing device is matched with the media source device.

When the playing device is matched with the media source device, the media source device can select, according to the received code value from the remote control device, whether to modify by itself an element in the page currently provided by the media source device or to transmit the received code value to the matched playing device to cause the playing device to modify an element in its currently displayed page.

The code value is generated by pressing down one of the buttons on the remote control device. At least one button may be arranged on the remote control device, and code values generated by pressing different buttons are different. Thus, the remote control device can identify an instruction corresponding to the code value. For example, the instruction of the code value may be used to instruct to increase a volume element, or instruct to decrease a backlight brightness element, or instruct to select or deselect a menu element, or the like.

Step 407 is to detect, by the media source device, whether the element that is determined by the code value to be modified exists in the page currently provided by the media source device.

For all or parts of elements in various pages provided in the media source device, relationship between code values used to modify these elements and these elements that can be modified with the code values may be preset respectively.

Optionally, the media source device may store at least one set of a first correspondence, and each first correspondence includes a code value and an element and is used to indicate that the element in the first correspondence can be modified by the code value in the first correspondence. Optionally, the first correspondence stored in the media source device may be classified according to the various pages provided by the media source device.

The elements described herein generally are those that determine playing effects of multimedia, such as backlight, brightness, volume, channels, menus and so on. The code value can adjust a value of the corresponding element, or modify a property of the corresponding element, such as modifying a brightness value, a volume value, or a selected property of a menu.

Step 408 is to modify, by the media source device, the element according to the code value when the element that is determined by the code value to be modified exists in the page currently provided by the media source device, and forbid the code value from being sent to the playing device.

When the element that is determined by the code value to be modified exists in the page currently provided by the media source device, this indicates that the element in the page currently provided by the media source device can be modified with the code value, and the media source device can modify the element according to this code value.

In general design, one code value is only used to modify an element once. Thus, when designing modification to an element in a page provided by the media source device and modification to an element in a page displayed by the playing device, the same code value can only be used to modify one of the element in the page provided by the media source device and the element in the page displayed by the playing device at a time.

Thus, when the media source device has modified the element according to the code value, the media source device can forbid the code value from being sent to the playing device so as to avoid influence on the element in the page displayed by the playing device.

Optionally, when the media source device modifies the element according to the code value, the element may be modified according to the received code value, according to pre-stored modification patterns that modify elements according to code values. The pre-stored modification patterns at least include adjusting a value of the corresponding element according to the code value or modifying the property of the corresponding element according to the code value.

For example, the code value is used to indicate turning a value of some element in backlight elements one level up. After the media source device receives the code value, the media source device determines that the element corresponding to the code value exists in the page currently provided by the media source device. Then, the media source device turns the value of the element one level up.

Step 409 is to send, by the media source device, the code value to the playing device connected with the media source device, when the element that is determined by the code value to be modified does not exist in the page currently provided by the media source device.

When the element that is determined by the code value to be modified does not exist in the page currently provided by the media source device, in order to avoid such a situation to happen that ignoring the code value causes adjustment effects desired by the user cannot be achieved, the media source device further is required to send the code value to the playing device connected with the media source device, to cause the playing device to determine whether to perform element adjustments according to the code value.

Step 410 is to receive, by the playing device, the code value sent by the media source device connected with the playing device.

Step 411 is to detect, by the playing device, whether an element that is determined by the code value to be modified exists in a page currently displayed by the playing device.

Similarly, for all or parts of elements in various pages provided by the playing device, relationship between code values used to modify these elements and these elements that can be modified with the code values may be preset respectively.

Optionally, the playing device may store at least one set of a second correspondence, and each second correspondence includes a code value and an element and is used to indicate that the element in the second correspondence can be modified by the code value in the second correspondence. Optionally, the second correspondence stored in the playing device may be classified according to the various pages provided in the playing device.

Step 412 is to adjust, by the playing device, the element that is determined by the code value to be modified, according to the code value, when the element that is determined by the code value to be modified exists in the page currently displayed by the playing device.

Similarly, when the playing device adjusts the element that is determined by the code value to be modified according to the code value, the element may also be modified according to the received code value, according to pre-stored modification patterns that modify elements according to code values. The pre-stored modification patterns at least include adjusting a value of the corresponding element according to the code value or modifying a property of the corresponding element according to the code value.

According to the above, in the method for adjusting elements provided in the embodiments of the present disclosure, the media source device receives the code value sent from the remote control device, and determines whether to modify an element in a currently provided page according to the code value. When no element is to be modified, then the media source device transmits the code value to the playing device to cause the playing device to modify an element in a currently displayed page. Because only one remote control device is required to implement controlling of the media source device and the playing device, thus the method can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. The method may achieve such effects that a single remote control device can be used to control the media source device and the playing device simultaneously, operation is simple and a hit ratio of the remote control device can be increased.

In an optional embodiment, the media source device may perform element synchronization first when determining that the media source device is matched with the playing device which is connected with the media source device, so as to ensure a consistency of the playing effects for the media source device and the playing device. Specifically FIG. 4B is referred to hereinafter.

Step 413 is to send, by the media source device, elements of predetermined types in the media source device to the playing device, when the playing device is matched with the media source device.

In actual applications, the playing device may have the same elements, such as backlight, volume and so on, as the media source device. In such a case, in order to ensure the consistency of the playing effects for the media source device and the playing device, values of the same elements in the playing device and the media source device (i.e., the elements of predetermined types) may be synchronized first after determining that the playing device is matched with the media source device.

For example, the values of both volumes are adjusted to be the same; or both of the backlight elements are adjusted to be the same.

Optionally, the media source device sends the elements of predetermined types in the media source device to the playing device, to cause the playing device to synchronize values of elements of predetermined types in the playing device with the values of the elements of predetermined types in the media source device.

Step 414 is to receive, by the playing device, the elements of predetermined types sent by the media source device.

Step 415 is to synchronize, by the playing device, corresponding elements in the playing device according to the elements of predetermined types, and send the synchronized elements to the media source device.

After the playing device synchronizes the corresponding elements in the playing device according to the elements of predetermined types, the playing device sends the synchronized elements to the media source device in order to ensure that the playing device can play based on the synchronized elements.

Step 416 is to receive, by the media source device, the synchronized elements fed back from the playing device.

After the media source device receives the synchronized elements fed back from the playing device, the media source device may provide playing data and playing environment to the playing device according to synchronized data.

Optionally, the steps 413 to 416 may be preformed prior to the step 406 of receiving, by the media source device, the code value sent by the remote control device shown in FIG. 4A.

From these, it can be known that by synchronizing the values of the same elements between the media source device and the playing device first after determining that the media source device is matched with the playing device, the consistency of the playing effects can be effectively assured when playing the multimedia contents subsequently.

In a representative application instance, if the playing device connected with the media source device is not turned on, the playing device normally cannot respond to the handshake request successfully after the media source device sends the handshake request to the playing device connected with the media source device, i.e., the playing device cannot feed the handshake response back to the media source device. In such a case, the playing device needs to be turned on so as to ensure that the playing device can normally play the multimedia contents provided by the media source device.

In a representative implementation, if not receiving the handshake response fed back by the playing device, the media source device sends to the playing device a turn-on signal for turning on the playing device. The playing device is turned on upon receiving the turn-on signal.

In a representative application instance, when the playing device is not matched with the media source device, it indicates that the playing device and the media source device cannot identify the same code values. Thus, in such a case, the media source device is forbidden to send the elements of predetermined types in the media source device to the playing device. The media source device is also forbidden to send the received code value to the playing device. That is, the media source device does not perform element synchronization with one playing device not matched with the media source device, and the media source device does not send code values to one playing device not matched with the media source device.

FIG. 5 is a schematic diagram of the media source device provided in at least one embodiment of the preset disclosure. The media source device may include a code-value receiving module 502, a detection module 502, an element modification module 503, and a code-value sending module 504.

The code-value receiving module 501 is to receive a code value sent from the remote control device. The code value is generated by pressing down one of buttons on the remote control device.

The detecting module 502 is to detect whether the element that is determined by the code value to be modified exists in the page currently provided by the media source device.

The element modification module 503 is to, when the detection module 502 detects that the element that is determined by the code value to be modified exists in the page currently provided by the media source device, modify the element according to the code value.

The code-value sending module 504 is to, when the detection module 502 detects that the element that is determined by the code value to be modified does not exist in the page currently provided by the media source device, send the code value to the playing device connected with the media source device to cause the playing device to modify the element that is determined by the code value to be modified in the page currently displayed by the playing device according to the code value.

According to the above, in the media source device provided in the embodiments of the present disclosure, the media source device receives the code value sent from the remote control device, and determines whether to modify elements in currently provided pages according to the code value. When no element is to be modified, then the media source device transmits the code value to the playing device to cause the playing device to modify elements in the currently displayed page. Because only one remote control device is required to implement controlling of the media source device and the playing device, thus it can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. It may achieve such effects that a single remote control device can be used to control the media source device and the playing device simultaneously, operation is simple and a hit ratio of the remote control device can be increased.

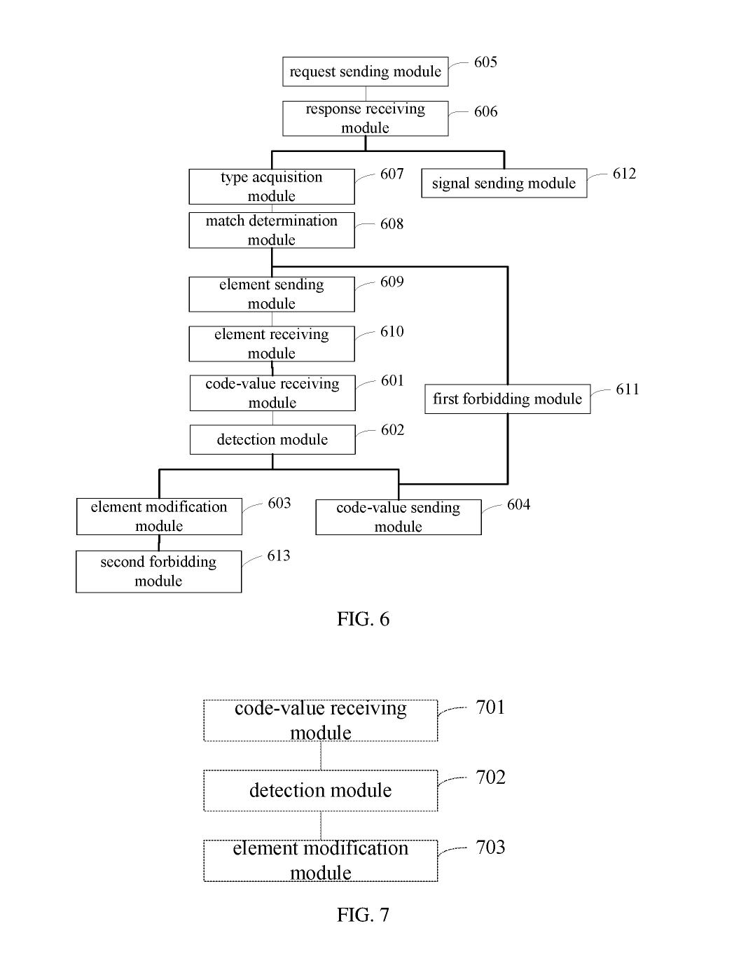

FIG. 6 is a schematic diagram of a media source device provided in at least one embodiment of the preset disclosure. The media source device may include a code-value receiving module 601, a detection module 602, an element modification module 603, and a code-value sending module 604.

The code-value receiving module 601 is to receive a code value sent from the remote control device. The code value is generated by pressing down one of the buttons on the remote control device.

The detecting module 602 is to detect whether the element that is determined by the code value to be modified exists in the page currently provided by the media source device.

The element modification module 603 is to, when the detection module 602 detects that the element that is determined by the code value to be modified exists in the page currently provided by the media source device, modify the element according to the code value.

The code-value sending module 604 is to, when the detection module 602 detects the element that is determined by the code value to be modified does not exist in the page currently provided by the media source device, send the code value to the playing device connected with the media source device to cause the playing device to modify the element that is determined by the code value to be modified in the page currently displayed by the playing device according to the code value.

In a representative implementation, the media source device may further include a request sending module 605, a response receiving module 606, a type acquisition module 607 and a match determination module 608.

The request sending module 605 is to send a handshake request to the playing device connected with the media source device after the media source device is turned on. The handshake request is to trigger the playing device to feed back a handshake response which carries the type of the playing device.

The response receiving module 606 is to receive the handshake response fed back from the playing device.

The type acquisition module 607 is to acquire the type of the playing device carried in the handshake response received by the response receiving module 606.

The match determination module 608 is to determine whether the playing device is matched with the media source device according to a stored list of types of playing devices and the acquired type of the playing device. The list of types stores at least one type of playing device matched with the media source device.

In a representative implementation, the media source device further includes an element sending module 609 and an element receiving module 610.

The element sending module 609 is to, when the match determination module 608 determines that the playing device is matched with the media source device, send elements of predetermined types in the media source device to the playing device to cause the playing device to synchronize the elements of predetermined types. The elements of predetermined types are those predetermined to be synchronized between the playing device and the media source device.

The element receiving module 610 is to receive the synchronized elements fed back from the playing device.

In a representative implementation, the media source device further includes a first forbidding module 611.

The first forbidding module 611 is to, when the match determination module 608 determines that the playing device is not matched with the media source device, forbid the element sending module 609 to send the elements of predetermined types in the media source device to the playing device, and forbid the media source device to send the received code value to the playing device.

In a representative implementation, the media source device further includes a signal sending module 612.

The signal sending module 612 is to, when the handshake response fed back by the playing device is not received by the response receiving module 606, send to the playing device a turn-on signal for turning on the playing device.

In a representative implementation, the media source device further includes a second forbidding module 613.

The second forbidding module 613 is to, after the element is modified according to the code value, forbid sending the code value to the playing device.

In a representative embodiment, the element modification module 603 may be further to modify the element according to the received code value, based on a modification pattern pre-stored for modifying elements according to code values. The modification pattern at least includes adjusting a value of corresponding element according to the code value.

According to the above, in the media source device provided in the embodiments of the present disclosure, the media source device receives the code value sent from the remote control device, and determines whether to modify an element in the currently provided page according to the code value. When no element is to be modified, then the media source device transmits the code value to the playing device to cause the playing device to modify an element in the currently displayed page. Because only one remote control device is required to implement controlling of the media source device and the playing device, thus it can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. It may achieve such effects that a single remote control device can be used to control the media source device and the playing device simultaneously, operation is simple and a hit ratio of the remote control device can be increased.

FIG. 7 is a schematic diagram of a playing device provided in at least one embodiment of the preset disclosure. The playing device may include a code-value receiving module 701, a detection module 702 and an element modification module 703.

The code-value receiving module 701 is to receive a code value sent from the media source device connected with the playing device. The code value is generated by pressing down one of the buttons on the remote control device and sent to the media source device.

The detection module 702 is to detect whether the element that is determined by the code value to be modified exists in the page currently displayed by the playing device.

The element modification module 703 is used to, when the detection module 702 detects that the element that is determined by the code value to be modified exists in the page currently displayed by the playing device, adjust the element that is determined by the code value to be modified according to the code value.

According to the playing device provided in the embodiments of the present disclosure, the media source device receives the code value sent from the remote control device, and determines whether to modify an element in a currently provided page according to the code value. When no element is to be modified, then the media source device transmits the code value to the playing device to cause the playing device to modify an element in a currently displayed page. Because only one remote control device is required to implement controlling of the media source device and the playing device, thus it can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. It may achieve such effects that a single remote control device can be used to control the media source device and the playing device simultaneously, operation is simple and a hit ratio of the remote control device can be increased.

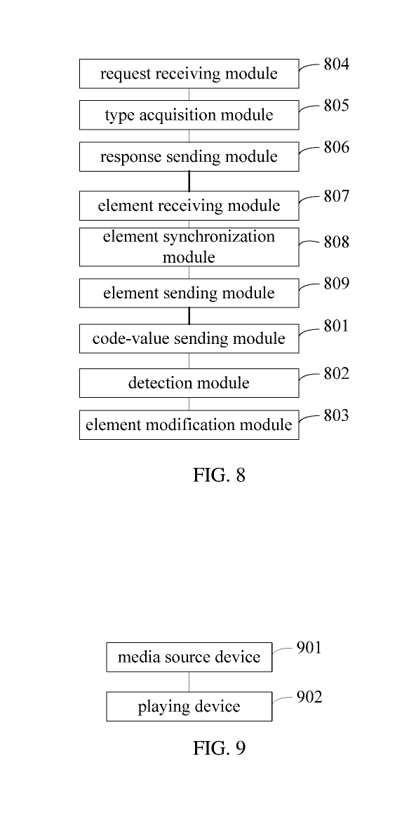

FIG. 8 is a schematic diagram of a playing device provided in at least one embodiment of the preset disclosure. The playing device may include a code-value receiving module 801, a detection module 802 and an element modification module 803.

The code-value receiving module 801 is to receive a code value sent from the media source device connected with the playing device. The code value is generated by pressing down one of the buttons on the remote control device and sent to the media source device.

The detection module 802 is to detect whether the element that is determined by the code value to be modified exists in the page currently displayed by the playing device.

The element modification module 803 is to, when the detection module 802 detects that the element that is determined by the code value to be modified exists in the page currently displayed by the playing device, modify the element that is determined by the code value to be modified according to the code value.

In a representative implementation, the playing device further includes a request receiving module 804, a type acquisition module 805, and a response sending module 806.

The request receiving module 804 is to receive a handshake request sent by the media source device.

The type acquisition module 805 is to acquire the type of the playing device.

The response sending module 806 is to add the type of the playing device acquired by the type acquisition module 805 into a handshake response and send the handshake response to the media source device.

In a representative implementation, the playing device further includes an element receiving module 807, an element synchronization module 808, and an element sending module 809.

The element receiving module 807 is to receive the elements of predetermined types sent by the media source device.

The element synchronization module 808 is to synchronize corresponding elements in the playing device according to the elements of predetermined types received by the element receiving module 807.

The element sending module 809 is to send the elements synchronized by the element synchronization module 808 to the media source device.

According to the playing device provided in the embodiments of the present disclosure, the media source device receives the code value sent from the remote control device, and determines whether to modify an element in a currently provided page according to the code value. When no element is to be modified, then the media source device transmits the code value to the playing device to cause the playing device to modify an element in a currently displayed page. Because only one remote control device is required to implement controlling of the media source device and the playing device, thus it can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. It may achieve such effects that a single remote control device can be used to control the media source device and the playing device simultaneously, operation is simple and a hit ratio of the remote control device can be increased.

It should be noted that the media source device and the playing device provided in the above embodiment are exemplified only by the above module divisions for various functions when adjusting elements. However, in actual applications, the functions may be distributed to be done by different modules according to requirements. That is, inner structures of the media source device and the playing device may be divided into different functional modules to implement all or part of the above functions described above. In addition, the media source device and the playing device provided in the above embodiments share the same concept with the above embodiment of service adjustment method. Details of implementation of the media source device and the playing device refer to embodiments of the method, which are not repeated herein.

FIG. 9 is a schematic diagram of a system for adjusting elements provided in at least one embodiment of the present disclosure. The system includes a media source device 901 and a playing device 902.

The description of the media source device 901 may be found in FIG. 5 or FIG. 6, and the description of the playing device 902 may be found in FIG. 7 or FIG. 8, both of which are not repeated herein.

According to the system for adjusting elements provided in the embodiments of the present disclosure, the media source device receives the code value sent from the remote control device, and determines whether to modify an element in a currently provided page according to the code value. When no element is to be modified, then the media source device transmits the code value to the playing device to cause the playing device to modify an element in a currently displayed page. Because only one remote control device is required to implement controlling of the media source device and the playing device, thus it can solve the problem in related art that the hit ratio that one of the remote controls hits its corresponding device is low, which is caused because each set of the television and the Set-Top-Box is configured with two remote controls and one user often confuses the device that one of the two remote controls can control when the user uses the different remote controls to control the television and the Set-Top-Box, respectively. It may achieve such effects that a single remote control device can be used to control the media source device and the playing device simultaneously, operation is simple and a hit ratio of the remote control device can be increased.

A sequence of the above embodiments of the present disclosure is only for the purpose of description, but does not represent priority levels of the embodiments.

It can be easily understood by one skilled in the art that all of parts of steps in the above embodiments may be preformed either by hardware or by instructing relevant hardware using programs. The programs may be stored in a computer readable storage medium which may be a read-only memory, a magnetic disk, a compact disk or the like.

The above descriptions are only preferred embodiments of the present disclosure, but are not used to limit the present disclosure. All modifications, equivalences and improvements made in the spirit and principle of the present disclosure are included in the protection scope of the present disclosure.

1. A method for adjusting an element, which is applied to a media source device, the method comprising:
receiving a code value sent from a remote control device, the code value being generated by pressing down one of buttons on the remote control device;
detecting whether an element that is determined by the code value to be modified exists in a page currently provided by the media source device;
modifying the element that is determined by the code value to be modified according to the code value when the element that is determined by the code value to be modified exists in the page currently provided by the media source device; and
sending the code value to a playing device connected with the media source device when the element that is determined by the code value to be modified does not exist in the page currently provided by the media source device, to cause the playing device to modify the element that is determined by the code value to be modified in a page currently displayed by the playing device.

2. The method according to claim 1, further comprising:
after the media source device is turned on, sending a handshake request to the playing device connected with the media source device, the handshake request being configured to trigger the playing device to feed back a handshake response which carries a type of the playing device;
receiving the handshake response fed back from the playing device;
acquiring the type of the playing device carried in the handshake response; and
determining whether the playing device is matched with the media source device according to a stored list of types of playing devices and the type of the playing device, the list of types storing at least one type of one playing device matched with the media source device.

3. The method according to claim 2, wherein after determining whether the playing device is matched with the media source device, the method further comprises:
when the playing device is matched with the media source device, sending elements of predetermined types in the media source device to the playing device to cause the playing device to synchronize the elements of predetermined types, the elements of predetermined types being elements predetermined to be synchronized between the playing device and the media source device; and
receiving synchronized elements fed back from the playing device.

4. The method according to claim 2, wherein after determining whether the playing device is matched with the media source device, the method further comprises:
when the playing device is not matched with the media source device, forbidding sending the elements of predetermined types in the media source device to the playing device, and forbidding the media source device to send a received code value to the playing device.

5. The method according to claim 2, wherein after sending the handshake request to the playing device connected with the media source device, the method further comprises:
when not receiving the handshake response fed back by the playing device, sending to the playing device a turn-on signal for turning on the playing device.

6. The method according to claim 1, wherein after modifying the element that is determined by the code value to be modified according to the code value, the method further comprises:
forbidding sending the code value to the playing device.

7. The method according to claim 1, wherein modifying the element that is determined by the code value to be modified according to the code value comprises:
based on a modification pattern pre-stored for modifying elements using code values, modifying the element that is determined by the code value to be modified according to the code value;
wherein the modification pattern at least comprises adjusting a value of a corresponding element according to the code value or adjusting a property of the corresponding element according to the code value.

8. A method for adjusting an element, which is applied to a playing device, the method comprising:
receiving a code value sent from a media source device connected with the playing device, the code value being generated by pressing down one of buttons on a remote control device and sent to the media source device;
detecting whether an element that is determined by the code value to be modified exists in a page currently displayed by the playing device;
adjusting the element that is determined by the code value to be modified according to the code value, when the element that is determined by the code value to be modified exists in the page currently displayed by the playing device.

9. The method according to claim 8, further comprising:
receiving a handshake request sent by the media source device;
acquiring a type of the playing device; and
adding the type of the playing device into a handshake response and sending the handshake response to the media source device.

10. The method according to claim 8, further comprising:
receiving elements of predetermined types sent by the media source device;
synchronizing corresponding elements in the playing device according to the elements of predetermined types; and
sending synchronized elements to the media source device.

11-20. (canceled)

21. An element adjustment system, comprising:
a media source device; and
a playing device connected with the media source device;
wherein the media source device comprises:
a code-value receiving module configured to receive a code value sent from a remote control device, the code value being generated by pressing down one of buttons on the remote control device;
a detection module configured to detect whether an element that is determined by the code value to be modified exists in a page currently provided by the media source device;
an element modification module configured to modify the element that is determined by the code value to be modified according to the code value, when the detection module detects that the element that is determined by the code value to be modified exists in the page currently provided by the media source device; and
a code-value sending module configured to, when the detection module detects that the element that is determined by the code value to be modified does not exist in the page currently provided by the media source device, send the code value to the playing device to cause the playing device to modify the element that is determined by the code value to be modified in a page currently displayed by the playing device according to the code value;
wherein the playing device comprises:
a code-value receiving module configured to receive the code value sent from the media source device connected with the playing device;
a detection module configured to detect whether the element that is determined by the code value to be modified exists in the page currently displayed by the playing device;
an element modification module configured to adjust the element that is determined by the code value to be modified according to the code value, when the detection module detects that the element that is determined by the code value to be modified exists in the page currently displayed by the playing device.

22. The system according to claim 21, wherein the media source device further comprises:
a request sending module configured to, after the media source device is turned on, send a handshake request to the playing device connected with the media source device, the handshake request being configured to trigger the playing device to feed back a handshake response which carries a type of the playing device;
a response receiving module configured to receive the handshake response fed back from the playing device;
a type acquisition module configured to acquire a type of the playing device carried in the handshake response received by the response receiving module; and
a match determination module configured to determine whether the playing device is matched with the media source device according to a stored list of types of playing devices and the type of the playing device, the list of types storing at least one type of one playing device matched with the media source device.

23. The system according to claim 22, wherein the media source device further comprises:
an element sending module configured to, when the match determination module determines that the playing device is matched with the media source device, send elements of predetermined types in the media source device to the playing device to cause the playing device to synchronize the elements of predetermined types, the elements of predetermined types being elements predetermined to be synchronized between the playing device and the media source device; and
an element receiving module configured to receive synchronized elements fed back from the playing device.

24. The system according to claim 22, wherein the media source device further comprises:
a first forbidding module configured to, when the match determination module determines that the playing device is not matched with the media source device, forbid the element sending module to send the elements of predetermined types in the media source device to the playing device, and forbid the media source device to send the received code value to the playing device.

25. The system according to claim 22, wherein the media source device further comprises:
a signal sending module configured to, when the response receiving module does not receive the handshake response fed back by the playing device, send to the playing device a turn-on signal for turning on the playing device.

26. The system according to claim 21, wherein the media source device further comprises:
a second forbidding module configured to forbid sending the code value to the playing device after the element is modified according to the code value.

27. The system according to claim 21, wherein the element modification module is further configured to:
based on a modification pattern pre-stored for modifying elements using code values, modify the element according to the received code value, the modification pattern at least comprising adjusting a value of a corresponding element according to the code value or adjusting a property of the corresponding element according to the code value.

28. The system according to claim 21, wherein the playing device further comprises:
a request receiving module configured to receive a handshake request sent by the media source device;
a type acquisition module configured to acquire a type of the playing device; and
a response sending module configured to add the type of the playing device acquired by the type acquisition module into a handshake response and send the handshake response to the media source device.

29. The system according to claim 21, wherein the playing device further comprises:
an element receiving module configured to receive elements of predetermined types sent by the media source device;
an element synchronization module configured to synchronize corresponding elements in the playing device according to the elements of predetermined types received by the element receiving module; and
an element sending module configured to send the elements synchronized by the element synchronization module to the media source device.
